(19) United States
(12) Patent Application Publication
(10) Pub. No.: US 2008/0250649 A1
(43) Pub. Date: Oct. 16, 2008

(54) Apparatus For Effecting Hair-Removal and Cleaning on Body Parts in Sanitary or Medical Ambits

(75) Inventor: Michael Spigai, Buti (PI) (IT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: O.M.G. S.R.L., Cascine di Buti (PI) (IT)

(21) Appl. No.: 12/090,952

(22) PCT Filed: Oct. 23, 2006
(86) PCT No.: PCT/IT2006/000750

§ 371 Date: Apr. 21, 2008

(30) Foreign Application Priority Data
Oct. 25, 2005 (IT) PI2005A000116
Aug. 18, 2006 (IT) PI2006U000016

(51) Int. Cl. B26B 19/38; B26B 19/44

(52) U.S. Cl. 30/133

(57) ABSTRACT

An apparatus (10) for effecting hair-removal and consequent cleaning on body-parts, in preparation for surgery or specific diagnostic examinations-comprises suction means housed in a main frame (11) provided with an opening (13) whose shape and size are apt to allow sucking in the removed hair, or fragments of hair, and cutting and/or shaving means (32) fastened to the apparatus (10) in a position congruent with the position of said opening (13). Said cutting and/or shaving means (32) are preferably fastened in a removable way and they comprise electric or hand-operated razors. The apparatus (10) also comprises tanks (34) and ducts (35) for emollient substances and at least a collecting tank (19) for hair, or fragments of hair. The apparatus is powered or by the standard electric power supply network other by batteries housed inside handling means (22).

### FIELD OF THE INVENTION

The present invention relates to an apparatus for effecting cleaning procedures on body parts in preparations for operations in sanitary ambits.

In particular the invention relates to a hair-removing and cleaning apparatus useful in preparation for surgery or some kind of medical or diagnostic examinations.

### BACKGROUND OF THE INVENTION

Existing shaving techniques, in preparation for surgery or specific diagnostic examinations, provide, as known, the use of razors, preferably electric razors to avoid the risk of abrasion which may cause bacteria proliferation, and scissors when long hair have to be shortened. The consequent cleaning, also useful to check that hair have been accurately removed from the involved body part, is usually performed by using dry surgical gauzes; cut or removed hair are finally gathered in some way to provide discard.

The lack of specific instruments makes the above procedures rough mainly because of the random spreading of hair, or fragments of hair, in the area surrounding the depilated body part.

For the same reasons said hair-removing and consequent cleaning take long time in view of the fact that a high level of hygiene is required in medical/sanitary ambits.

Therefore, it worth to look for technical solutions apt to avoid, or at least reduce, the above disclosed problems relating to the lack of specific means that, in addiction to hair-removing, allows an effective and preferably contemporaneous cleaning of the involved body part.

### SUMMARY OF THE INVENTION

The main object of the present invention is to provide an apparatus which enables faster and more systematic hair-removing and consequent cleaning actions on the body part in a sanitary ambit.

Further object of the present invention is to provide an apparatus which enables effectively getting rid of hair and other waste matters of the depilation made in preparation for surgery or specific medical examinations.

Said objects are attained by an apparatus for effecting cleaning procedures on body parts, in preparation for surgery or specific diagnostic examinations, comprising suction means housed in a main frame provided with at least one inlet port apt to enable the entrance of hair, fragments of hair or waste matters, at least one collecting tank connected in a removable way to said main frame, handling means of the apparatus.

Said inlet port of the main frame is advantageously put in communication with the body part to be operated upon through a suction conduit provided with an end part comprising the handling means and cutting and/or shaving means. These lasts comprise razors with rotary or reciprocating motion, with electric feeding or hand-operated, restrained in a fixed or detachable way.

Said cutting and/or shaving means may also be fastened directly to the main frame of the apparatus.

The apparatus furthermore comprises at least one tank for emollient substances and its, at least one, duct adducting said substances towards the body part to be operated upon.

The suction means are preferably fans operated by electric actuators. The collecting tank is connected to the main frame by rapid fastenings, such as bayonet caps, screw means or other means.

According to a specific embodiment, said suction means are powered by batteries housed in the handling means of the apparatus. The suction means may otherwise be powered by the electric power supply network.

A brush like accessory is connected in correspondence to the inlet port provided in the main frame or in correspondence to the aperture of the end part of the suction conduit, in order to facilitate the suction of the cut or shaved hair, or fragments of hair, said brush being a single-use sterile accessory which can be connected in a removable way.

From the above features clearly descend the advantages coming from the use of an apparatus according to the invention during the cleaning procedures in preparation for surgery or specific medical examinations, as it enables effective and fast hair-removing and cleaning operations on the body part to be operated upon and the involved area.

### BRIEF DESCRIPTION OF THE DRAWINGS

For a better understanding of the characteristics and the advantages of the present invention, various embodiments will now be described by way of examples with reference to the accompanying drawings, in which:

FIG. 1 shows a longitudinal section view of an apparatus according to a first embodiment of the invention;

FIG. 2 shows a longitudinal section view of an apparatus according to a second embodiment of the invention;

FIG. 3 shows a longitudinal section view of an apparatus according to a further embodiment of the invention;

FIG. 4 shows a schematic view of an apparatus according to a further embodiment of the invention.

### DESCRIPTION OF PREFERRED EMBODIMENTS

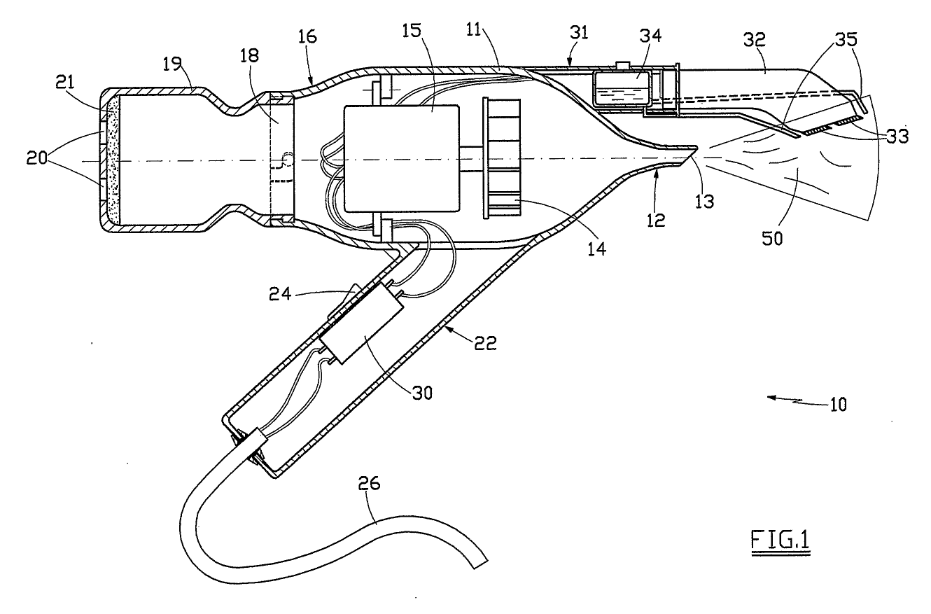

Referring to FIG. 1 is shown as a whole with 10 an apparatus for effecting hair-removal and cleaning on body parts, in preparation for surgery or specific medical examinations.

The apparatus comprises a main frame, 11, preferably in plastic material, having, in this embodiment, a substantially cylindrical shape tapered at one end, 12, provided with an inlet port, 13, directly communicating with the outer space. Inside said main frame, 11, is housed a fan, 14, having axis of rotation coincident with the longitudinal axis of said main frame, said fan being operated by a coaxial electric actuator, 12, so that it raises an air flow from the end section comprising the inlet port 13 towards the opposite end section, 16.

To this second end section of the main frame 11 is connected, by rapid fastenings 18, a collecting tank, 19, gathering hair and various particles of the air flow produced by the fan 14 and sucked in by the apparatus through the inlet port 13. It is to be noticed that the air flow produced by the fan passes through the apparatus coming out from holes, 20 of the bottom surface of the tank 19, whilst hair, fragments of hair or particles are retained by a sponge filter, 21, or similar kind of filter, placed in correspondence to said bottom surface.

On one side, the main frame 11 has a hollow protrusion, 22, acting as a handle of the apparatus 10; in said protrusion 22 are housed, in this embodiment of the invention, breaking and regulating means, 30, of the electric feeding of the apparatus, from the standard power supply network to which the apparatus is connected through the cable 26, said means, 30, being operated by a switch, 24, bound to the external surface of the protrusion 22.

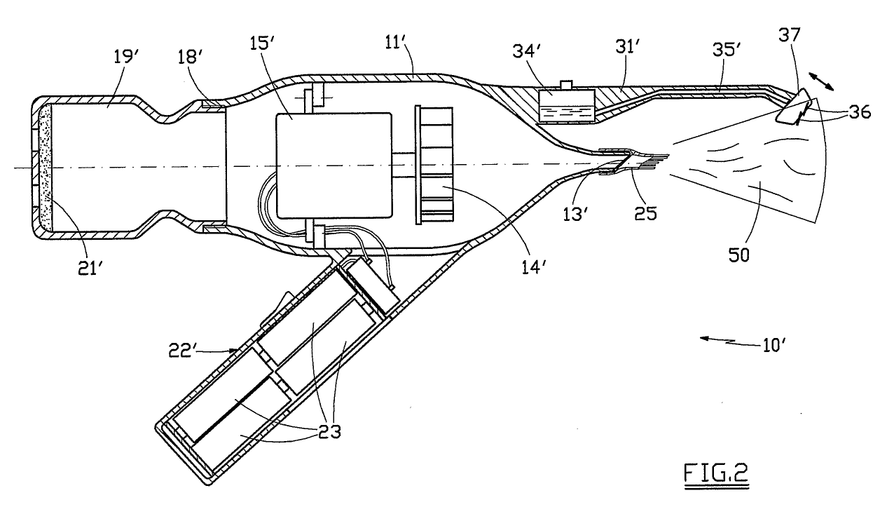

Alternatively, as shown in FIG. 2, in the hollow protrusion 22′ are housed rechargeable batteries, 23, apt to assure an adequate working range to the apparatus.

On the side opposite the side of the handle 22, the main frame provides a hollow protuberance, 31, growing in a direction substantially parallel to the longitudinal axis of the main frame of the apparatus, said protuberance 31 being intended to support cutting and/or shaving means for removing hair from the body part undergoing surgery or medical examination. In the embodiment of FIG. 1, said cutting and/or shaving means are an electric razor, 32, whose shaving heads, 33, are arranged inside the suction working-volume, 50, in front of the inlet port 13. The protuberance 31 also houses a tank, 34, for an emollient substance which is brought close to the heads 33 through apposite ducts 35.

It has to be noticed that in particular embodiments, such as the one shown in FIG. 2, said ducts of the tank 34 may be directly housed inside the protuberance, 31′, so bringing the emollient substance directly to the shaving means, arrangement which is particularly useful when these lasts comprise parallel blades, 36, as the ones of the hand-operated razor 37 used in this case.

It is useful to underline that both the hand-operated razor 37 and the electric razor 32 can be fastened to their respective housing protuberances, 31 or 31′, in a removable way, so that they can be easily detached and replaced or undergo maintenance.

The electric razor 32 is powered by the same means feeding the electric actuator 15 of the fan 14, both if they are the standard power supply network and if they are rechargeable batteries 23.

Alternatively, the electric razor 32 comprises its own batteries, which can be recharged separately as well as by the electric power supply means of the apparatus 10.

As regards the collecting tank for hair, fragments of hair or waste matters, it can be seen that in FIG. 2 it is connected to the main frame, 11′, of the apparatus by screw means 18′. Both this kind of fastening and the one shown in FIG. 1 allow an easy and fast connection and removal of the tank 19, or 19′, which, after the end of the cleaning procedures, can be emptied from the collected hair and other waste matters, by pulling out the sponge 21, or 21′, in order to wash the hair or waste matters away from the sponge itself, or replace it if necessary.

It is also shown in FIG. 2 that in correspondence to the inlet port 13′ is put, in a removable way, a brush, 25, apt to facilitate the suction of hair or other particles, it preferably being a single-use sterile brush.

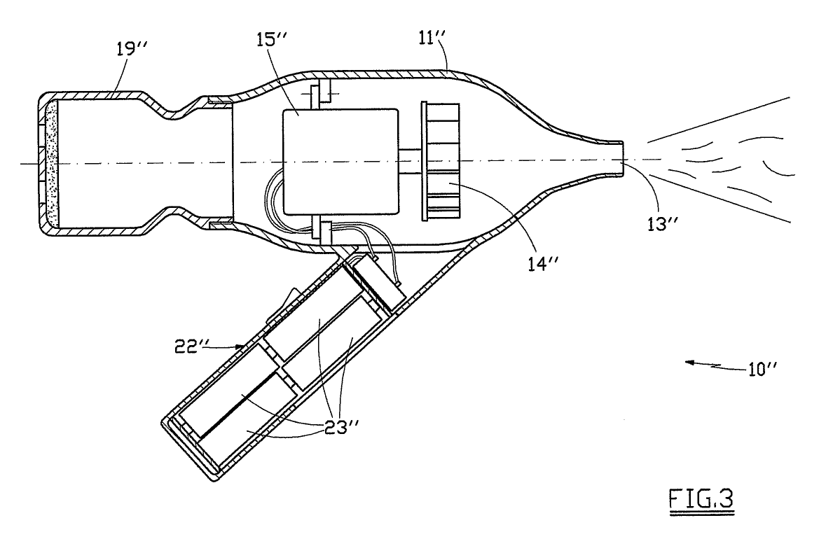

In the embodiment of FIG. 3 is shown an apparatus according to the invention, lacking the cutting and/or shaving means but provided with the suction means, 14″, 15″, apt to clear away hair, or waste matters, from the body part to be operated upon through the inlet port 13″ towards the collecting tank 19″.

Also in this case the apparatus is powered by batteries 23″ housed in the handling means 22″.

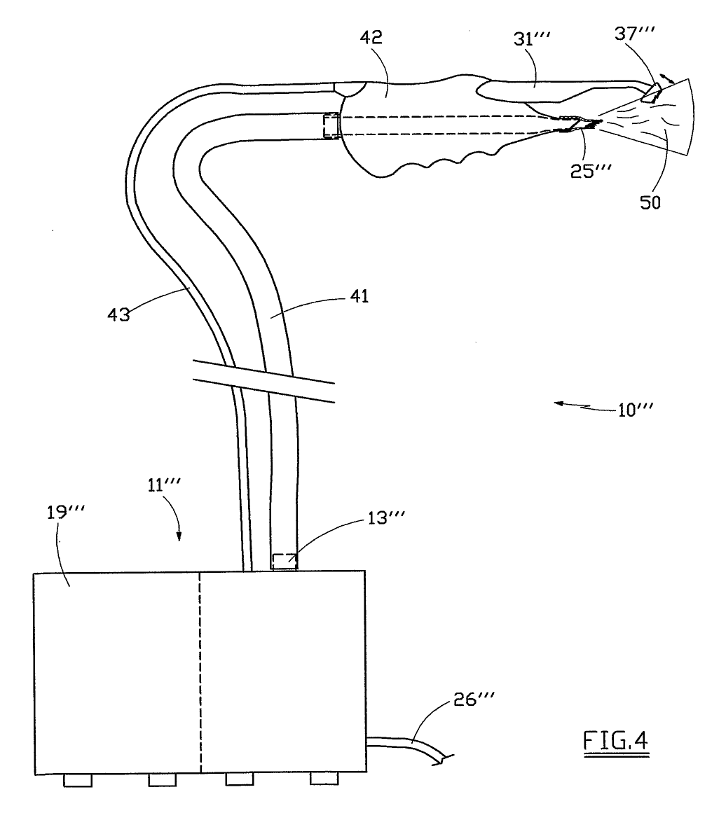

In the embodiment of FIG. 4 the inlet port 13′″ of the main frame 11′″ is put in communication with the body part to be operated upon through a suction conduit, 41, ending in an end part, 42, comprising the handling means and the protuberances 31′″ supporting the cutting and/or shaving means 37′″. In this embodiment the brush 25′″ is, obviously, put at the aperture of the end part 42 instead of on the inlet port 13′″.

The main frame 11′″ comprises a section housing the suction means, composed of the fan and its electric actuator, and a tank 19′″ for collecting hair or other waste matters.

The apparatus 10′″ is powered by the standard power supply network where is lo connected through the cable 26′″. A further cable, 43, supply electric power from the main frame 11′″ to the end part 42, in order to serve possible uses, such as, for instance, the emollient substance adduction device or an electric razor if it replaces the hand-operated razor 37′″.

The operating way of the hair-removing and cleaning apparatus according to the invention is immediately clear from the above.

The hair-removing phase by cutting takes place, in particular, through the use of an apparatus according to FIG. 1, provided with an electric razor having cutting heads with reciprocating motion. Stopping, in this case, the flow of the emollient substances from the tank 34, the cutting phase occurs after powering on the fan 14 and the electric razor 32. The heads 33 of the razor 32 are positioned in such a way that their working area is inside the suction working volume, 50, of the suction means, so that cut hair are automatically sucked in the main frame 11 and gathered in the collecting tank 19.

It is clear that the suction may continue, if necessary, after the end of the cutting phase, by switching off the razor 32 and keeping powered just the actuator 15 of the fan 14.

The hair-removing phase by shaving takes place through the use of an apparatus provided with a hand-operated razor, as shown in FIG. 2 or FIG. 4, as well as with an electric razor, as in FIG. 1, having rotary shaving heads.

In this case as well the suction of hair and the shaving phase are contemporaneous, taking place this last inside the suction working volume 50. The suction itself is completed with a drying phase of the body part whenever is enabled the flow of emollient substances through the ducts 35 or 35′; furthermore, suction is make easier thanks to the use of the brush 25, 25′ put in correspondence to the aperture provided to let hair or fragments enter the apparatus 10 or 10′″.

There is no doubt that the use of the brush 25 greatly facilitate the cleaning phase, but, obviously, the cleaning phase is still effective if the apparatus without said brush is used, as shown in FIG. 1 or FIG. 3.

Certainly, both cutting and shaving may be performed, in view of different conditions of use, with the utilization of apparatus according to the invention with its own power supply means, for example batteries, as well as with a connection to the electric power supply network.

Moreover, when cutting and/or shaving are performed by separate cutting and/or shaving means, the cleaning phase may be advantageously executed through the simpler apparatus of FIG. 3. Precisely, once removed hair from the body part to be prepared for surgery or medical examination, whatever instrument has been used, scissors or razors with relating heads, the body part to be operated upon is cleaned by simply switching on the apparatus 10′″ and, operating it in correspondence to said body part, sucking in and gathering shaved hair and waste matters.

Finally, no matters whether hair-removing means are used or not, and independently from the kind of them, whichever power supplying means are provided, the embodiment of FIG. 4 enables the fix positioning of the main frame, 11′″, because only the end part 42 needs to be operated in correspondence to the body part to be operated upon.

The advantages relating to the practicality and easy of use of the hair-removing and cleaning apparatus of the invention keep safe also in case of further modifications and changes, with respect to what above disclosed.

The overall shape of the main frame of the apparatus may change, taking different sizes and proportions, still useful for performing cleaning and hair-removing operations; also the shape of the handling means and the shape of the protuberance supporting the cutting and/or shaving means may vary.

The suction means may obviously be different with respect to the one shown in the appended drawings.

The cutting and/or shaving means may be fastened to the apparatus, in particular to their supporting protuberance, in a different way, still assuring the greater flexibility of use proper of the apparatus, and allowing the execution of cutting and/or shaving together with the suction phase as well as at different times, with the cutting/shaving means connected, or not connected to the apparatus.

The tank for emollient substances may be variously placed and shaped with respect to the disclosed embodiments.

The collecting tank for hair and waste matter may have a different volume and shape with respect to the ones shown in the disclosed embodiment. It may also be not completely detachable but, for instance, it may provide just an opening to allow inspection, emptying and cleaning.

The handling means may obviously vary; in fact they may be obtained through variously shaped and placed protrusions or, moreover, the apparatus may be handled thanks to a special shape of the main frame 11, with reference to the embodiments of FIGS. 1, 2, or 3 or thanks to the shape of the end part 42, with reference to the embodiment of FIG. 4.

The suction conduit 41 may be connected or in a fix other in a removable way, both to the main frame 11′″ and to the end part 42.

These ones and further changes or modification may be carried out to the apparatus for effecting cleaning procedures on body parts, in preparation for surgery or specific diagnostic examinations, according to the invention, always remaining in the ambit of protection of the following claims.

1. Apparatus for effecting cleaning procedures on body parts, in preparation for surgery or specific diagnostic examinations, characterized in that it comprises suction means housed in a main frame provided with at least one inlet port apt to enable the entrance of hair, fragments of hair or waste matters, at least one collecting tank for said hair, fragments or waste matters, and handling means.

2. Apparatus according to claim 1 characterized in that said inlet port (13′″) of the main frame (11′″) is in communication with the body part to be operated upon through a suction conduit (41) provided with an end part (42).

3. Apparatus according to claim 1 characterized in that said cleaning procedures comprise hair-removing and sucking operations, said hair-removal being performed through cutting and/or shaving means (32, 37, 37′″) fastened to the apparatus (10, 10′, 10′″).

4. Apparatus according to claim 3 characterized in that said cutting and/or shaving means comprise electric razors (32) with rotary or reciprocating motion.

5. Apparatus according to claim 4 characterized in that said cutting and/or shaving means (32) are powered by the electric power supply means of the apparatus.

6. Apparatus according to claim 3 characterized in that said cutting and/or shaving means comprise hand-operated razors (37).

7. Apparatus according to claim 3 characterized in that said cutting and/or shaving means (32, 37, 37′″) are fastened to the apparatus (10, 10′, 10′″) in a removable way.

8. Apparatus according to claim 3 characterized in that it comprises at least a tank (34, 34′) for emollient substances adducting said substances towards the body part to be operated upon.

9. Apparatus according to claim 3 characterized in that said apparatus (1 0, 10′, 10′″) comprises protuberances (31, 31′, 31′″) supporting said cutting and/or shaving means (32, 37, 37′″).

10. Apparatus according to claim 3 characterized in that said cutting and/or shaving means are fastened to said apparatus (10, 10′, 10′″) in such a way that their working area is inside the suction working volume (50, 50′, 50′″) of said suction means.

11. Apparatus according to claim 1 characterized in that said at least one collecting tank (19, 19′, 19″, 19′″) for gathering hair, fragments of hair or waste matters, is connected to said main frame (11, 11′, 11″, 11′″) in a removable way.

12. Apparatus according to claim 11 characterized in that said at least one collecting tank (19) is connected in a removable way to said main frame (11) through rapid fastenings (18) comprising bayonet caps or similar fastening means.

13. Apparatus according to claim 1 characterized in that said collecting tank for gathering hair, fragments of hair and waste matters, is connected in a removable way to said main frame through an apposite duct.

14. Apparatus according to claim 1 characterized in that said suction means comprise fans (14, 14′, 14″) operated by electric actuators (15, 15′, 15″).

15. Apparatus according to claim 1 characterized in that it comprises batteries (23, 23′) apt to power at least one of the means of the apparatus.

16. Apparatus according to claim 1 characterized in that said handling means are hollow protrusions (22, 22′, 22″) of said main frame (11, 11′, 11″), said batteries (23, 23″) being housed inside said handling means (22, 22′, 22″).

17. Apparatus according to claim 1 characterized in that at least one of the means of the apparatus is operated by electricity and is powered by a standard electric power supply network.

18. Apparatus according to claim 1 characterized in that said inlet port (13, 13′, 13″) of said main frame (11, 11′, 11″) or said end part (42) is provided with a brush (25, 25′″) for facilitating the suction of hair, fragments of hair or waste matters.

19. Apparatus according to claim 18 characterized in that said brush (25, 25′″) is a single-use sterile accessory which can be connected in a removable way.
